(19) United States
(12) Patent Application Publication
(10) Pub. No.: US 2005/0068585 A1
(43) Pub. Date: Mar. 31, 2005

(54) Image conversion apparatus and image conversion program storage medium

(75) Inventor: Osamu Shimizu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/944,820

(22) Filed: Sep. 21, 2004

(30) Foreign Application Priority Data
Sep. 25, 2003 (JP) 2003-333579

(51) Int. Cl. H04N 1/52; H04N 1/56

(52) U.S. Cl. 358/2.1; 358/534; 358/515; 358/527; 358/536; 358/540

(57) ABSTRACT

The present invention provides an image conversion apparatus that converts an input image having process color components and a spot color component and represented by density data for the respective colors into a halftone dot image represented by halftone dot data. A first halftoning means changes the process color components into halftone dots, a spot color separation means separates the spot color component into two or more colors, a second halftoning means changes the two or more colors into halftone dots using, for example, a halftone dot sort which is higher in screen ruling than that of a halftone dot sort used in the first halftoning means, and a halftone dot composition means composites the halftone dots of each process color component of the two or more colors provided by the second halftoning means with the halftone dots of the corresponding process color component provided by the first halftoning means.

### BACKGROUND OF THE INVENTION

1. Field of the Invention

The present invention relates to an image conversion apparatus that converts an input image having process color components and a spot color component and represented by density data for the respective colors into a halftone dot image represented by halftone dot data, and an image conversion program storage medium that stores an image conversion program that makes a computer operate as such an image conversion apparatus.

2. Description of the Related Art

Conventionally, when printing an image using a printing machine, a printer or the like is used to produce a proof image resembling the image to be printed by the printing machine before printing by the printing machine, thereby confirming whether a desired print will be provided or not. The printer for creating the proof image, or a computer system incorporating the printer is referred to as a proofer.

If something undesirable is found in the produced proof image, an edit condition or another condition that affects the final print in any way is adjusted to correct the undesirable, and then, a proof image is produced again.

By repeating creation of a proof image and modification of a condition in this way, the print conditions necessary for providing a desired final print can be determined.

When printing an image using a printing machine, process color inks of three colors of cyan (C), magenta (M) and yellow (Y), or four colors of C, M, Y and black (K) are used, and various colors are represented by halftone dots. In addition to these process colors, ink of a color to be represented, which is referred to as spot color ink, may be used.

Typically, when a printer produces a proof image that exhibits colors resembling those of the image to be printed using such a spot color ink, the printer does not use the particular spot color ink but represents the spot color by using a limited number of colors including the process color inks C, M, Y and K and other several colors, such as orange (O) and green (G), that can be used in the printer, for example.

In this case, the print image is represented by the process color inks and the spot color ink. The color of the spot color ink is separated into two or more colors, which can be selected from the colors used in the printer. Then, the density data for the two or more colors, each of which is any of C, M, Y and K, resulting from the separation of the spot color are each integrated with (typically, added to) the original density data for the corresponding one of the process colors C, M, Y and K. Then, the proof image is produced based on the density data for the colors of the ink that can be used in the printer.

Some proofers produce a proof image based on halftone dot data. In the case where such a proofer is used to produce a proof image for the image to be printed using a spot color, the density data for the inks of the colors that can be used in the printer are each converted into halftone dot data, and the proof image is produced based on the halftone dot data.

As described above, the proof image for the image to be printed using a spot color can be produced by separating the spot color into two or more colors, integrating the density data for process color(s) resulting from the separation with the original density data for the corresponding process color components(s), and producing the proof image based on the image data of the colors of the inks that can be used in the printer. However, on the proof image thus obtained, it is difficult to determine whether a certain area of the print image is represented by a spot color or a process color. Thus, there is a problem that the proof image lacks important information for evaluating the final print image.

In order to solve the problem, a proofer may produce a proof image using various spot colors. However, providing such a proofer is extremely expensive, and there are many kinds of spot colors, so that as many spot colors as can be used for printing cannot be prepared. Thus, providing such a proofer is impractical.

Furthermore, to solve the problem described above, in patent reference 1, there is proposed an image conversion apparatus that produces a proof image in which the areas represented by the process colors can be discriminated from each other. However, this image conversion apparatus is suitable only for a printer that represents colors using only process colors but not suitable for a printer using another color, such as orange (O) or green (G), in addition to the process colors.

[Patent reference 1] Japanese Patent Laid-Open No. 2003-78778

### SUMMARY OF THE INVENTION

The present invention has been in view of the above circumstances and provides an image conversion apparatus that is suitable for a proofer that uses a printer using process color inks and another color ink and produces a proof image using only the colors that can be used in the printer and performs data conversion suitable for production of a proof image in which the areas originally represented by the process colors can be discriminated from the area originally represented by a spot color, and an image conversion program storage medium that stores an image conversion program that makes a computer operate as such an image conversion apparatus.

In view of such circumstances, an image conversion apparatus according to the present invention is an image conversion apparatus that converts an input image having process color components and a spot color component and represented by density data for the respective colors into a halftone dot image represented by halftone dot data, including:
first halftoning means that changes the process color components of the input image into halftone dots using a predetermined halftone screen;
spot color separation means that separates the spot color component of the input image into two or more colors selected from among a group of the process colors and another predetermined color;
second halftoning means that changes the two or more colors derived from the spot color by the spot color separation means into halftone dots using a halftone dot sort different from the halftone dot sort used in the first halftoning means; and
halftone dot composition means that composites the halftone dots of each process color component of the two or more colors derived from the spot color component provided by the second halftoning means with the halftone dots of the corresponding process color component provided by the first halftoning means.

The image conversion apparatus according to the present invention separates the spot color into two or more colors, changes the two or more colors derived from the spot color into halftone dots using a halftone dot sort different from the halftone dot sort used in halftoning of the original process colors aside from halftoning of the original process colors, and compositing the halftone dot data separately obtained on a process-color basis. On the proof image produced based on the composite halftone dot data, the areas originally represented by the process colors can be discriminated from the areas represented by the spot color due to the different halftone screens.

In the image conversion apparatus according to the present invention, it is preferable that the second halftoning means changes the two or more colors derived from the spot color component by the spot color separation means into halftone dots using a halftone dot sort which is higher in screen ruling than the halftone dot sort used in the first halftoning means.

The spot color tends to be used for a solid area (an area of a high dot percent). Therefore, by using the halftone dot sort which is higher in screen ruling for the spot color component in separate halftoning of the process color components and the spot color component, the area represented by the spot color component can be enhanced on the proof image.

In addition, in the image conversion apparatus according to the present invention, the spot color separation means may separate the spot color into two or more colors selected from among a group of cyan, magenta, yellow, black, orange and green.

Printers used as a proofer often use inks of colors O and G in addition to C, M, Y and K.

In addition, in order to attain the object described above, an image conversion program stored in an image conversion program storage medium according to the present invention is an image conversion program that is executed in a computer and makes the computer operate as an image conversion apparatus that converts an input image having process color components and a spot color component and represented by density data for the respective colors into a halftone dot image represented by halftone dot data, including:
first halftoning means that changes the process color components of the input image into halftone dots using a predetermined halftone screen;
spot color separation means that separates the spot color component of the input image into two or more colors selected from among a group of the process colors and another color;
second halftoning means that changes the two or more colors derived from the spot color by the spot color separation means into halftone dots using a halftone dot sort different from the halftone dot sort used in the first halftoning means; and
halftone dot composition means that composites the halftone dots of each process color component of the two or more colors derived from the spot color component provided by the second halftoning means with the halftone dots of the corresponding process color component provided by the first halftoning means.

In the image conversion program described above, it is preferable that the second halftoning means changes the two or more colors derived from the spot color component by the spot color separation means into halftone dots using a halftone dot sort which is higher in screen ruling than the halftone dot sort used in the first halftoning means.

In addition, in the image conversion program described above, the spot color separation means may separate the spot color into two or more colors selected from among a group of cyan, magenta, yellow, black, orange and green.

As described above, according to the present invention, input image data represented by process color components and a spot color component can be converted into halftone dot image data which is used by a printer using process colors and an additional color to produce a proof image in which any area using the spot color in the print image can be distinguished.

### BRIEF DESCRIPTION OF THE DRAWINGS

FIG. 1 is a schematic diagram of the whole of a print proof system incorporating an image conversion apparatus according to an embodiment of the present invention;

FIG. 2 is a perspective view of a proofer shown in FIG. 1;

FIG. 3 shows a hardware configuration of the proofer;

FIG. 4 schematically shows an image conversion program storage medium according to an embodiment of the present invention;

FIG. 5 is a functional block diagram of an image conversion apparatus according to an embodiment of the present invention;

FIG. 6 shows an example of an input image;

FIG. 7 schematically shows image data that represents the input image;

FIG. 8 is a schematic diagram for illustrating an operation of first halftoning means;

FIG. 9 is a diagram for illustrating an operation of spot color separation means;

FIG. 10 is a diagram for illustrating an operation of second halftoning means; and

FIG. 11 is a diagram for illustrating an operation of halftone dot composition means.

### DETAILED DESCRIPTION OF THE INVENTION

Now, embodiments of the present invention will be described.

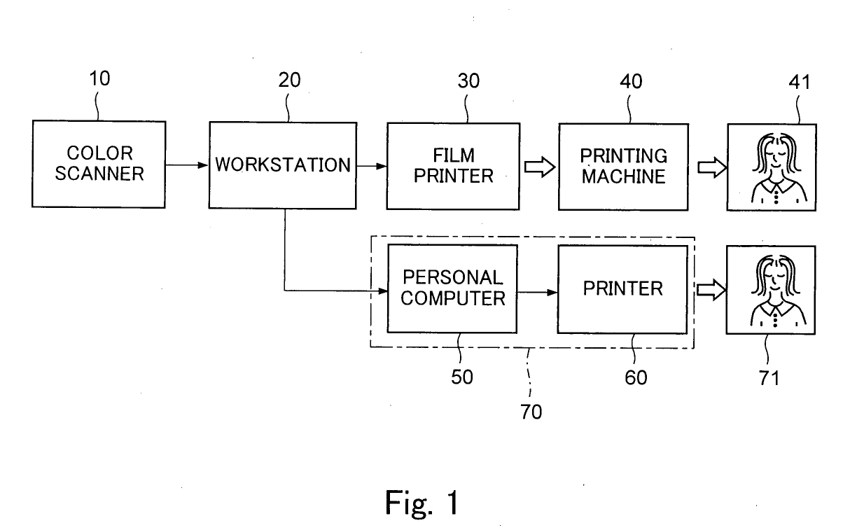

FIG. 1 is a schematic diagram of the whole of a print proof system incorporating an image conversion apparatus according to an embodiment of the present invention.

A color scanner 10 reads an original image and creates four pieces of color-separated image data for cyan (C), magenta (M), yellow (Y) and black (K) which represent the read original image. The C, M, Y and K image data are input to a workstation 20. An operator performs electronic assembly based on the input image data in the workstation 20. In the electronic assembly, spot color data, which relates to a color other than the four colors C, M, Y and K, is added to form image data representing an image for printing. The image data for printing represents an image formed by pixels each of which exhibits gradations of the four colors, C, M, Y and K and the spot color(s) To perform printing, the image data for printing is converted into image data for plate-making that represents a halftone dot image, and the image data for plate-making is input to a film printer 30, which produces a printing original film plate for each of the colors C, M, Y and K and the spot color(s) based on the image data for plate-making.

From the printing original film plates, a machine plate is produced, and the machine plate is installed in a printing machine 40. Inks are applied to the machine plate installed in the printing machine 40, the applied inks are transferred onto a printing sheet of paper, and thus, a print image 41 is formed on the sheet of paper.

The series of operations including production of the film original plates by the film printer 30, production of the machine plate and installation thereof in the printing machine 40, application of inks to the machine plate and printing onto a sheet of paper is extensive and expensive. Therefore, in advance of running on, a proofer 70 including a personal computer 50 and a printer 60 produces a proof image 71 as described below to check the final print image 41.

Production of the proof image 71 begins with input of the image data for printing resulting from electronic assembly in the workstation 20 to the personal computer 50. As described above, the image data for printing input to the personal computer 50 represents an image formed by pixels each of which exhibits gradations of the four colors, C, M, Y and K and the spot color(s). The personal computer 50 converts the image data for printing into proof image data suitable for the printer 60 that is to output the proof image 71. The proof image data is input to the printer 60, and the printer 60 produces the proof image 71 based on the proof image data.

In this example, the printer 60 can use inks of the four process colors, C, M, Y and K and two additional colors, orange (O) and green (G), and produces a halftone dot image formed by all or some of the six color inks. The proofer 70 receives the image data for printing from the workstation 20 shown in FIG. 1 via a computer network or a magneto-optical (MO) disk.

The proofer 70 produces the proof image based on the image data thus received. The final print image can be checked in advance by checking the proof image.

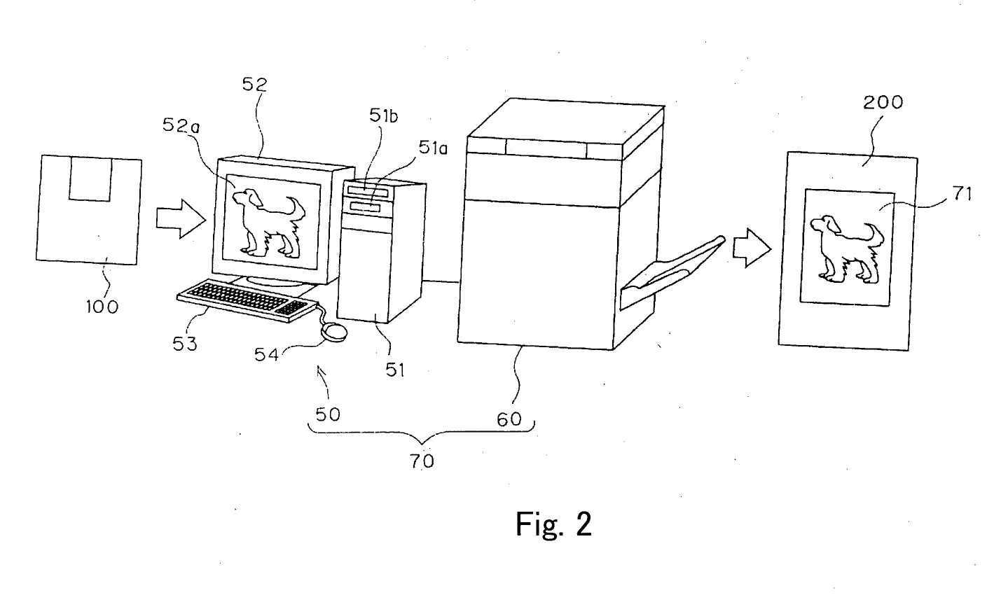

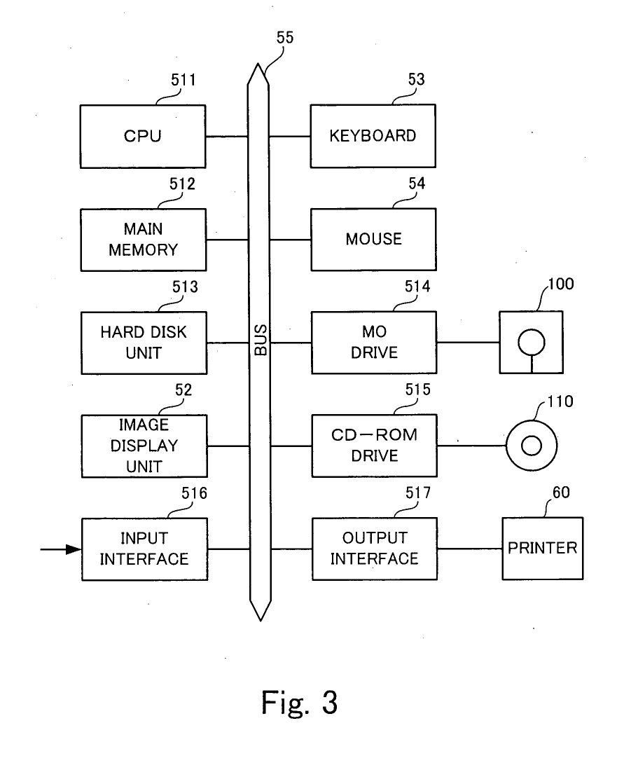

FIG. 2 is a perspective view of the proofer 70 shown in FIG. 1, and FIG. 3 shows a hardware configuration of the proofer 70.

As described above, the proofer 70 includes the personal computer 50 and the printer 60. Viewed from the outside, the personal computer 50 includes a main unit 51, an image display unit 52 that displays an image on a display screen 52a in response to an instruction from the main unit 51, a keyboard 53 for input of various kinds of information to the main unit 51 depending on key manipulations, and a mouse 54 for pointing to an icon or the like shown at any point on the display screen 52a to input the instruction assigned to the icon or the like. In addition, viewed from the outside, the main unit 51 has an MO loading slot 51a for loading of an MO disk 100 and a CD-ROM loading slot 51b for loading a CD-ROM. The personal computer 50 operates as the image conversion apparatus according to the embodiment of the present invention.

The printer 60 is a printer for outputting a proof image, which receives halftone dot data from the personal computer 50 and outputs the proof image 71 on a sheet of paper 200 in accordance with an instruction from the personal computer 50.

As shown in FIG. 3, the main unit 51 incorporates a CPU 511 that executes various programs, a hard disk unit 513 that retains various programs, image data and the like, a main memory 512 in which a program stored in and read from the hard disk unit 513 is developed for execution in CPU 511, an MO drive 514 for accessing the MO disk 100 loaded thereto, a CD-ROM drive 515 for accessing a CD-ROM 110 loaded thereto, an input interface 516 connected to the workstation 20 (see FIG. 1) to receive image data from the workstation 20, and an output interface 517 for transmitting image data to the printer 60. These components and the image display unit 52, the keyboard 53 and the mouse 54 shown in FIG. 2 are interconnected via a bus 55.

The CD-ROM 110 stores an image conversion program that makes the personal computer 50 operate as the image conversion apparatus according to the embodiment of the present invention. The CD-ROM 110 is loaded into the CD-ROM drive 515, and the image conversion program stored in the CD-ROM 110 is uploaded to the personal computer 50 and stored in the hard disk unit 513.

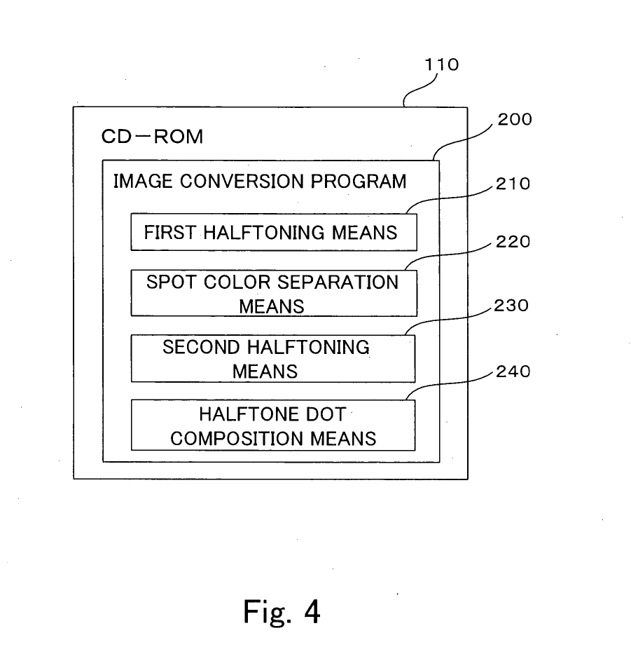

FIG. 4 schematically shows an image conversion program storage medium according to an embodiment of the present invention.

An image conversion program 200 is stored in the CD-ROM 110 and includes first halftoning means 210, spot color separation means 220, second halftoning means 230, and halftone dot composition means 240. Functions of the means 210 to 240 will be described later.

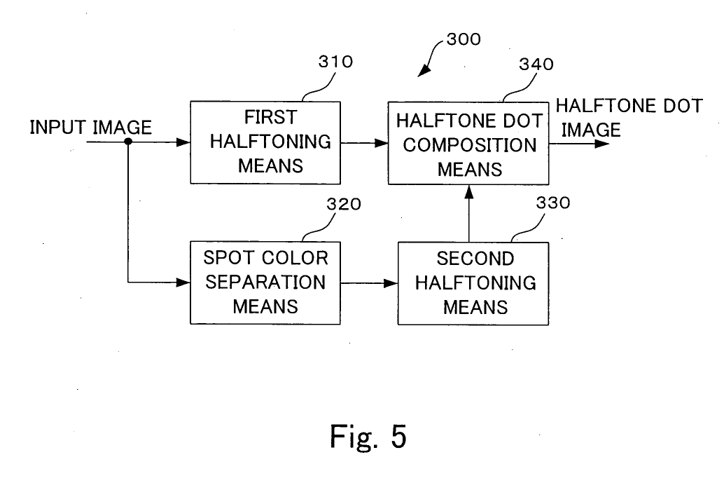

FIG. 5 is a functional block diagram of an image conversion apparatus according to an embodiment of the present invention.

An image conversion apparatus 300 is implemented by installing the image conversion program shown in FIG. 4 in the personal computer 50 shown in FIGS. 1 to 3. The image conversion apparatus 300 has first halftoning means 310, spot color separation means 320, second halftoning means 330 and halftone dot composition means 340.

The means 310 to 340 constituting the image conversion apparatus 300 correspond to the means 210 to 240 of the same names constituting the image conversion program shown in FIG. 4, respectively. However, the means 310 to 340 of the image conversion apparatus 300 in FIG. 5 are implemented by a combination of hardware and an operating system (OS) of the personal computer 50 shown in FIGS. 1 to 3 and an application program, while the means 210 to 240 of the image conversion program 200 in FIG. 4 are implemented only by an application program.

In the following, functions of the means 310 to 340 of the image conversion apparatus 300 shown in FIG. 5 will be described. This description can be applied to the functions of the means 210 to 240 of the image conversion program 200 shown in FIG. 4.

The image conversion apparatus 300 shown in FIG. 5 is implemented in the personal computer 50 shown in FIGS. 1 to 3. To the image conversion apparatus 300, an image represented by image data for printing including a spot color component, that is, an input image having process color components and a spot color component and represented by density data for the respective colors is input from the workstation shown in FIG. 1.

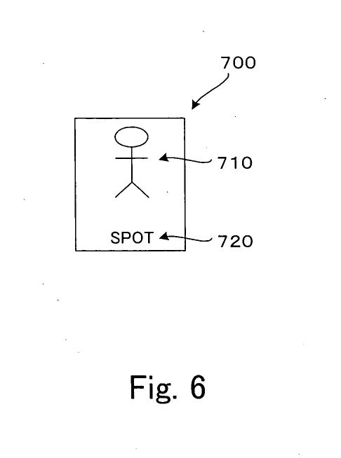

FIG. 6 shows an example of the input image.

An input image 700 has a partial image 710 represented by process colors C, M, Y and K and a partial image 720 represented by a spot color.

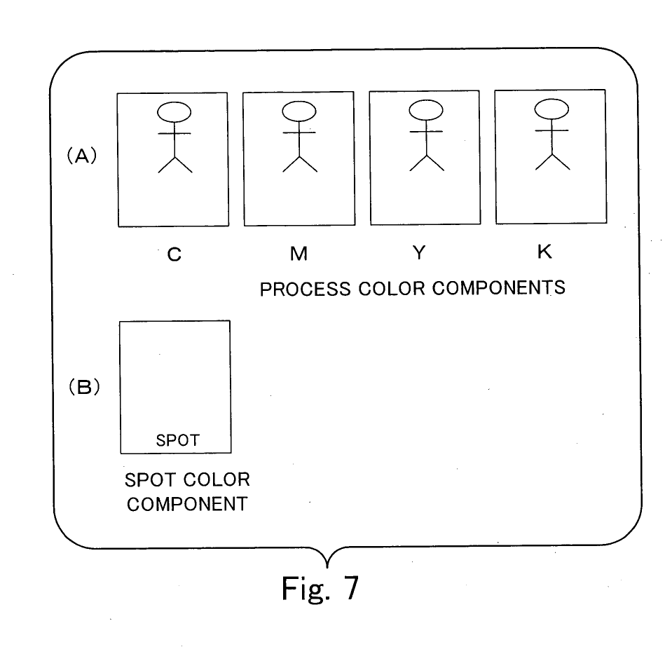

FIG. 7 schematically shows image data that represents the input image shown in FIG. 6.

The input image is represented by density data for the process color components C, M, Y and K shown in part (A) of FIG. 7 and density data for the spot color component shown in part (B) of FIG. 7. For simplicity of description, only one spot color is used in this example.

The input image input to the image conversion apparatus 300 shown in FIG. 5 is passed to the first halftoning means 310 and the spot color separation means 320.

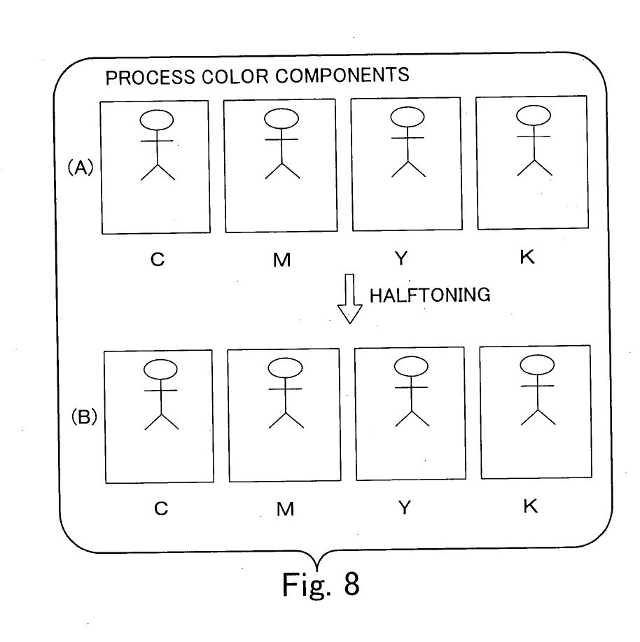

FIG. 8 is a schematic diagram for illustrating an operation of the first halftoning means 310.

Part (A) of FIG. 8 shows the same density data as the density data for the process colors C, M, Y and K shown in part (A) of FIG. 7. The first halftoning means 310 uses a first halftone dot sort to change the density data for the process color component C, M, Y and K into halftone dot data. Part (B) of FIG. 8 shows the C, M, Y and K components represented by the resulting halftone dot data.

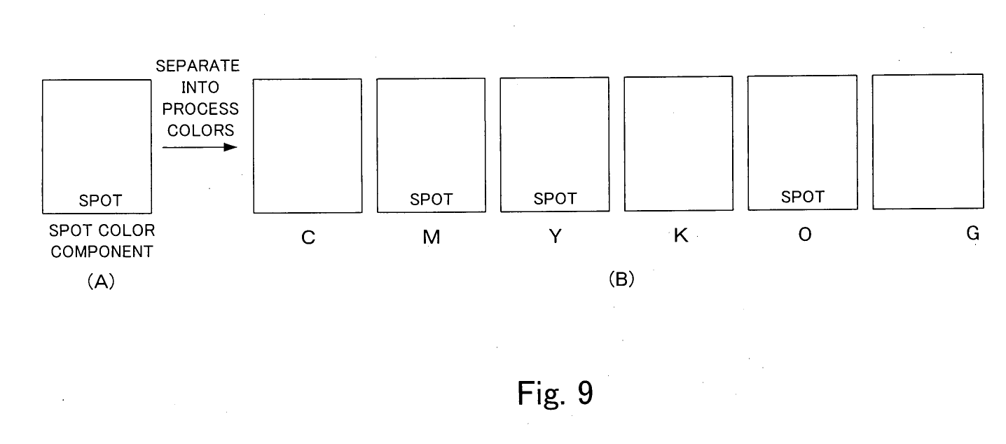

FIG. 9 is a diagram for illustrating an operation of the spot color separation means 320.

The spot color separation means 320 stores a correspondence table, such as Table 1 shown below, and separates the spot color into two or more of the colors C, M, Y, K, O and G by referring to the correspondence table.

TABLE 1

| spot color name | C | M | Y | K | O | G |
|---|---|---|---|---|---|---|
| spot color 1 | 30 | 20 | 5 | 0 | 0 | 0 |
| spot color 2 | 0 | 60 | 30 | 0 | 70 | 0 |
| spot color 3 | 80 | 0 | 20 | 0 | 0 | 100 |
| spot color 4 | 0 | 0 | 100 | 30 | 0 | 0 |
| spot color 5 | 0 | 0 | 0 | 30 | 0 | 100 |

In this Table 1, the spot color 1, the spot color 2, and so on are the names that specify the respective spot colors. The values in the fields of the colors C, M, Y, K, O and G for the spot color names indicate the dot percent of the respective colors, assuming that the spot colors have a solid density (that is, the spot colors have a dot percent of 100%) For example, the spot color of the name of spot color 2 (having a dot percent of 100%) is separated into magenta (M) having a dot percent of 60%, yellow (Y) having a dot percent of 30%, and orange (O) having a dot percent of 70%.

If the dot percent of the spot color before separation is not 100%, the dot percent of each color after separation is the product of the dot percent thereof shown in Table 1 and the dot percent of the spot color before separation. That is, if the spot color of the name of spot color 2 has a dot percent of 60%, the spot color 2 (having a dot percent of 60%) is separated into M having a dot percent of 36% (60% by 0.6), Y having a dot percent of 18% (30% by 0.6) and O having a dot percent of 42% (70% by 0.6).

Part (A) of FIG. 9 shows the same density data for the spot color as that shown in part (B) of FIG. 7. As shown in part (B) of FIG. 9, the spot color separation means 320 separates the density data for the spot color into density data for two or more colors selected from among C, M, Y, K, O and G. FIG. 9 shows an example of the spot color 2 shown in Table 1, that is, an example in which the density data for the spot color is separated into density data for three colors, M, Y and O.

The density data for the two or more colors derived from the spot color provided by the spot color separation means 320 in FIG. 5 are input to the second halftoning means 330.

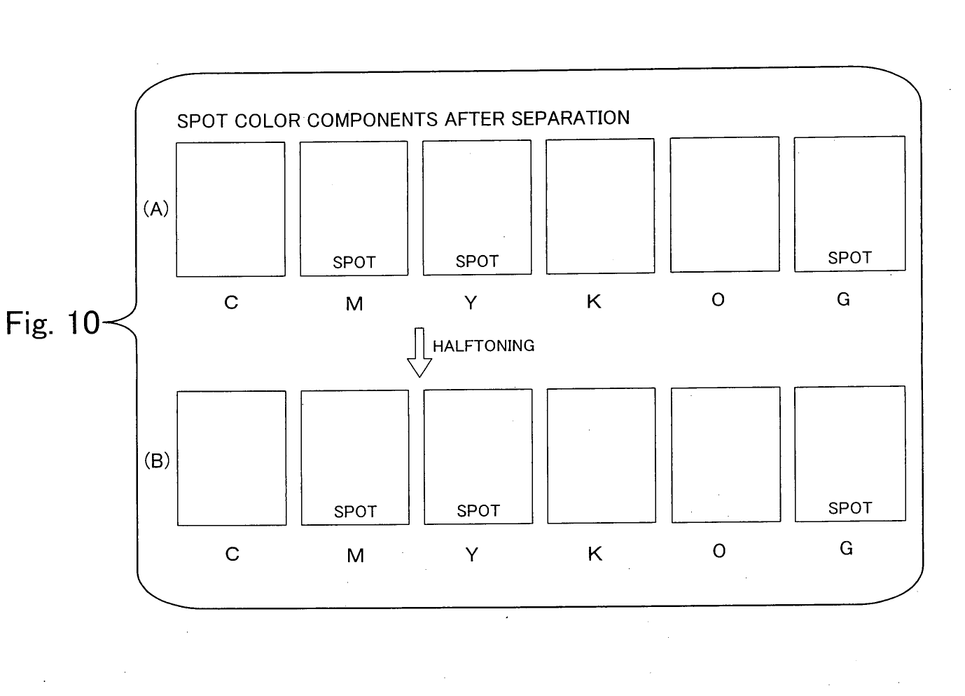

FIG. 10 is a diagram for illustrating an operation of the second halftoning means 330.

The second halftoning means 330 uses a second halftone dot sort to change each of the density data for the two or more colors (three colors M, Y and O in this example) received from the spot color separation means 320 into halftone dot data.

Part (A) of FIG. 10 shows the spot color components represented by the density data before halftoning, and part (B) of FIG. 10 shows the spot color components represented by the halftone dot data for the two or more colors, which are derived from the density data by halftoning using the second halftone screen.

The second halftone dot sort used by the second halftoning means 330 to change the spot color components into halftone dots is higher in screen ruling than the first halftone dot sort used by the first halftoning means 310 to change the process color components into halftone dots. For the same dot percent, using a halftone dot sort that is higher in screen ruling adds a more solid and uniform appearance to the resulting image. On the other hand, spot colors are often used for a solid area of an image. Thus, using the halftone dot sort of a finer screen ruling can give the impression of using a spot color.

The halftone dot data for the process color components generated by the first halftoning means 310 shown in FIG. 5 and the halftone dot data for the two or more colors derived from the spot color component generated by the second halftoning means 330 shown in FIG. 5 are input to the halftone dot composition means 340. In the halftone dot composition means 340, the halftone dot data for any process color component of the two or more colors derived from the spot color component is composited with the halftone dot data for the corresponding process color component from the first halftoning means 310. For example, in the example of the spot color 2 shown in Table 1, composition is performed on the halftone dot data for the two process colors M and Y.

In this embodiment, the “composition” is a process in which either of the halftone dot data is “1”, which indicates an area to which an ink is applied, the halftone dot data after composition is set to “1”, and both the halftone dot data are “0”, which indicates an area to which no ink is applied, the halftone dot data after composition is set to “0”.

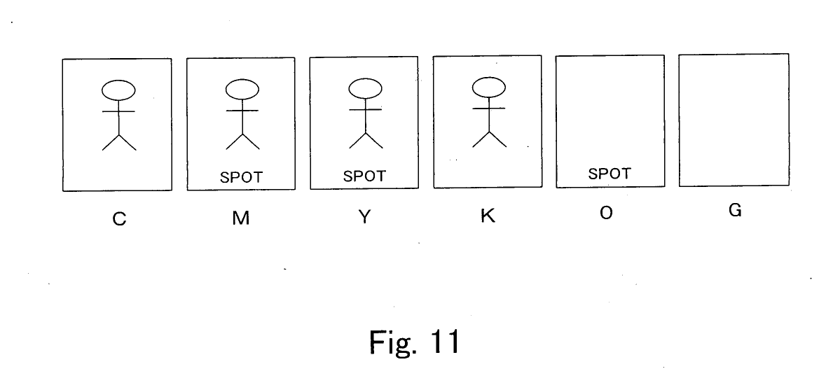

FIG. 11 is a diagram for illustrating an operation of the halftone dot composition means.

The halftone dot composition means 340 generates, through the composition process described above, halftone dot data represented by the colors C, M, Y, K, O and G with the process color components and the spot color components of the input image being represented with different halftone screens. In the example of the spot color 2 in Table 1 described here, green (G) is not used.

The halftone dot image represented by the halftone dot data for C, M, Y, K, O and G generated by the halftone dot composition means 340 is input to the printer 60 shown in FIGS. 1 and 2, and the printer 60 generates a proof image based on the halftone dot image (halftone dot data for C, M, Y, K, O and G).

The proof image includes areas that are represented by the process color inks on the print image and areas that are represented by the spot color inks thereon, which are represented using different halftone screens. An observer of the proof image can see where the spot colors are used and thus evaluate the proof image more appropriately.

While four process colors C, M, Y and K are used in the embodiment described above, the present invention can be applied to a case where three process colors C, M and Y are used. In addition, while two colors O and G are used besides the process colors in the embodiment described above, the present invention can be applied to a case where any one of O and G is used, or a case where a color other than O and G is used.

Furthermore, in this embodiment, the second halftoning means is described as using the second halftone dot sort that is higher in screen ruling than the first halftone dot sort used by the first halftoning means. However, any of the first and second halftone dot sorts may have a higher screen ruling. Such a different screen ruling is not essential. The process color components and the spot color components can be discriminated from each other in the proof image as far as the halftone screens differ from each other in any way. For example, the halftone screens may differ from each other in screen configuration rather than in screen ruling.

1. An image conversion apparatus that converts an input image having process color components and a spot color component and represented by density data for the respective colors into a halftone dot image represented by halftone dot data, comprising:
first halftoning means that changes the process color components of the input image into halftone dots using a predetermined halftone dot sort;
spot color separation means that separates the spot color component of the input image into two or more colors selected from among a group of the process colors and another predetermined color;
second halftoning means that changes the two or more colors derived from the spot color by the spot color separation means into halftone dots using a halftone dot sort different from the halftone dot sort used in the first halftoning means; and
halftone dot composition means that composites the halftone dots of each process color component of the two or more colors derived from the spot color component provided by the second halftoning means with the halftone dots of the corresponding process color component provided by the first halftoning means.

2. The image conversion apparatus according to claim 1, wherein the second halftoning means changes the two or more colors derived from the spot color component by the spot color separation means into halftone dots using a halftone dot sort which is higher in screen ruling than the halftone dot sort used in the first halftoning means.

3. The image conversion apparatus according to claim 1, wherein the spot color separation means separates the spot color into two or more colors selected from among a group of cyan, magenta, yellow, black, orange and green.

4. An image conversion program storage medium that stores an image conversion program that is executed in a computer and makes the computer operate as an image conversion apparatus that converts an input image having process color components and a spot color component and represented by density data for the respective colors into a halftone dot image represented by halftone dot data, the image conversion program comprising:
first halftoning means that changes the process color components of the input image into halftone dots using a predetermined halftone screen;
spot color separation means that separates the spot color component of the input image into two or more colors selected from among a group of the process colors and another predetermined color;
second halftoning means that changes the two or more colors derived from the spot color by the spot color separation means into halftone dots using a halftone dot sort different from the halftone dot sort used in the first halftoning means; and
halftone dot composition means that composites the halftone dots of each process color component of the two or more colors derived from the spot color component provided by the second halftoning means with the halftone dots of the corresponding process color component provided by the first halftoning means.
